(19) United States
(12) Patent Application Publication
(10) Pub. No.: US 2026/0123630 A1
(43) Pub. Date: May 7, 2026

(54) COMPOSITIONS INCLUDING ENCAPSULATED BIXLOZONE AND NON ENCAPSULATED BIXLOZONE

(71) Applicant: FMC CORPORATION, Philadelphia, PA (US)

(72) Inventors: Jesper HILDEBRANDT, Copenhagen (DK); David HENNENS, Bekkevoort (BE); Paul NICHOLSON, Ewing, NJ (US); Krishnan PALANICHAMY, Newark, DE (US)

(21) Appl. No.: 19/116,533

(22) PCT Filed: Sep. 29, 2023
(86) PCT No.: PCT/US2023/034075

§ 371 Date: Mar. 28, 2025

Related U.S. Application Data
(60) Provisional application No. 63/412,366, filed on Sep. 30, 2022.

(51) Int. Cl. A01N 43/80; A01N 25/28; A01P 13/02

(52) U.S. Cl. CPC A01N 43/80; A01N 25/28; A01P 13/02

(57) ABSTRACT

Described herein are compositions including encapsulated bixlozone and non-encapsulated bixlozone. Also described herein are methods of preparing the compositions. Also described herein are methods for controlling undesirable vegetation with the compositions.

### FIELD OF THE DISCLOSURE

Described herein are compositions including encapsulated bixlozone and non-encapsulated bixlozone. Also described herein are methods of preparing the compositions. Also described herein are methods for controlling undesirable vegetation with the compositions.

### BACKGROUND OF THE DISCLOSURE

Bixlozone compositions often balance crop safety and efficacy. Generally, encapsulated bixlozone is more selective, and therefore safer, but less efficacious compared to non-encapsulated bixlozone. Further, target crop injury and off-target crop injury, from spray drift, for example, must be considered. These balancing considerations limit formulations including bixlozone.

### BRIEF DESCRIPTION OF THE DISCLOSURE

It was discovered herein that compositions including both encapsulated bixlozone and non-encapsulated bixlozone are both safe and efficacious. A formulation including a mixture of encapsulated bixlozone and non-encapsulated bixlozone results in a surprising enhancement in safety such that off-target crop injury in the absence of a safener is comparable to off-target crop injury in the presence of a safener. In other words, a ZC bixlozone formulation (including a mixture of bixlozone CS and bixlozone SC) provides crop safety that is at least equal to, and often greater than, the level of safening that is provided by a traditional safener with non-encapsulated bixlozone (bixlozone SC). Additionally, a ZC bixlozone formulation also brings additional safety benefits to non-target plants when the non-target plants are exposed by a spray drift event by providing volatility control following application to the soil.

A safener is not strictly required in compositions including both encapsulated bixlozone and non-encapsulated bixlozone. Compositions including both encapsulated bixlozone and non-encapsulated bixlozone in a ZC formulation are effective and may be used in a variety of forms.

Enhanced target crop safety may also be achieved by adding a safener to a bixlozone ZC formulation. In these modified bixlozone ZC formulations, the bixlozone ZC formulation itself provides the majority of the safening effect.

In one embodiment, the present disclosure is directed to a composition comprising: (i) encapsulated bixlozone; (ii) non-encapsulated bixlozone; and (iii) optionally an additional active ingredient, wherein the composition does not comprise a safener.

In another embodiment, the present disclosure is directed to a method of preparing a composition, the method comprising: I) encapsulating bixlozone; and II) forming a mixture comprising: (i) the encapsulated bixlozone; (ii) non-encapsulated bixlozone; and iii) optionally an additional active ingredient, wherein the composition does not comprise a safener.

In yet another embodiment, the present disclosure is directed to a method for controlling undesirable vegetation, the method comprising applying to the undesirable vegetation or to a locus thereof or applying to a soil or crop to prevent an emergence or growth of the undesirable vegetation a composition comprising: (i) encapsulated bixlozone; (ii) non-encapsulated bixlozone; and (iii) optionally an additional active ingredient, wherein the composition does not comprise a safener.

### BRIEF DESCRIPTION OF THE DRAWINGS

FIG. 1 (FIG. 1) depicts an exemplary embodiment of early post-emergence applications of herbicidal compositions in accordance with the present disclosure. Twelve trials were performed for each composition.

FIG. 2 (FIG. 2) depicts an exemplary embodiment of early post-emergence applications of herbicidal compositions in accordance with the present disclosure. Twelve trials were performed for each composition with assessments by crop stage.

FIG. 3 (FIG. 3) depicts an exemplary embodiment of early post-emergence applications of herbicidal compositions in accordance with the present disclosure. Twelve trials were performed for each composition with assessments by crop stage.

FIG. 4 (FIG. 4) depicts an exemplary embodiment of early post-emergence applications of herbicidal compositions, followed by harvest without any negative impact on quantity and quality, in accordance with the present disclosure. Four trials were performed for each composition with grouped assessment timings.

FIG. 5 (FIG. 5) depicts an exemplary embodiment of post-seeding pre-emergence applications of herbicidal compositions in accordance with the present disclosure.

FIG. 6 (FIG. 6) depicts an exemplary embodiment of post-seeding pre-emergence applications of herbicidal compositions in accordance with the present disclosure.

### DETAILED DESCRIPTION OF THE DISCLOSURE

This written description uses examples to illustrate the present disclosure, including the best mode, and also to enable any person skilled in the art to practice the disclosure, including making and using any compositions or systems and performing any incorporated methods. The patentable scope of the disclosure is defined by the claims, and may include other examples that occur to those skilled in the art. Such other examples are intended to be within the scope of the claims if they have elements that do not differ from the literal language of the claims, or if they include equivalent elements with insubstantial differences from the literal language of the claims.

As used herein, the terms “comprises,” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”. The use of “consisting essentially of” herein allows the applicant, as lexicographer, to define the invention being claimed by excluding any material, step, feature or method that is considered by the applicant to be non-critical to the claimed invention, but which may be known in the prior art and otherwise can be included in the invention being claimed, whether or not such inclusion or exclusion is specifically described in the specification. Exclusion of any material, step, feature or method by the applicant may be for the sole purpose of excluding elements of the prior art that affect the novelty and, therefore, the patentability of the invention being claimed. As such, the use of “consisting essentially of” herein does not require explicit support from the specification to exclude any element of the prior art from the invention being claimed if inclusion of said element is detrimental to the patentability of the invention claimed.

Where an invention or a portion thereof is defined with an open-ended term such as “comprising,” it should be readily understood that (unless otherwise stated) the description should be interpreted to also describe such an invention using the terms “consisting essentially of” or “consisting of.”

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular. The term “optionally” in connection with an ingredient or method in the present formulation alternatively means “present or absent”. The “optional” component is “present” or “absent” independent of the presence or absence of other formulating ingredients or steps unless otherwise noted or recited.

As used herein, depending on the context in which it is used, the term “about” provides an estimate of a value associated with the claimed invention, where the estimated value is reasonable when taken in context with the description of the invention and in view of what is known from information available to the public, as such information would be understood or interpreted by a person of ordinary skill in the art. Generally, the term “about” as used herein means that the estimated value will fall within plus or minus 10% of the associated value. Bixlozone is a herbicide recently introduced by FMC with the CAS name of 2-(2,4-dichlorophenyl)methyl-4,4-dimethyl-3-isoxazolidinone. For convenience, bixlozone is sold commercially as (a formulated material as) “Overwatch” and has also been referred to as “DCPM1”, “F9600”, “2,4-DC” and “dichloroclomazone”. In one embodiment bixlozone may be technical grade bixlozone with purity range of 90 to 95% by weight. In another embodiment, the bixlozone may be a composition comprising more than 95% by weight pure 2-(2,4-dichlorophenyl)methyl-4,4-dimethyl-3-isoxazolinone. In another embodiment “pure bixlozone” means 100% pure 2-(2,4-dichlorophenyl)methyl-4,4-dimethyl-3-isoxazolinone.

As used herein, “wt %” refers to the weight percent of the recited component relative to the total weight of the recited composition.

Embodiments of this disclosure can be combined in any manner.

Composition embodiments of the present disclosure include:

Embodiment A1. The composition described in the Summary of the Invention, wherein the non-encapsulated bixlozone is provided by the SC component of the formulation.

Embodiment A2. The composition described in Embodiment A1, wherein the encapsulated bixlozone is provided by the CS component of the formulation.

Embodiment A3. The composition of Embodiment A1 wherein the bixlozone in the SC component of the formulation is available for diffusion upon dilution.

Embodiment A4. The composition of Embodiment A2 wherein the bixlozone in the CS component of the formulation is not available for diffusion upon dilution.

Embodiment A5. The composition of Embodiment A4 wherein the bixlozone in the CS component of the formulation is available to the locus of the vegetation after application.

Embodiment B1. The composition described in the Summary of the Invention, wherein the encapsulated bixlozone and the non-encapsulated bixlozone are present in a ratio in the range of from about 1:9 to about 9:1.

Embodiment B2. The composition described in Embodiment B1, wherein the encapsulated bixlozone and the non-encapsulated bixlozone are present in a ratio in the range of from about 1:8 to about 8:1.

Embodiment B3. The composition described in Embodiment B2, wherein the encapsulated bixlozone and the non-encapsulated bixlozone are present in a ratio in the range of from about 1:7 to about 7:1.

Embodiment B4. The composition described in Embodiment B3, wherein the encapsulated bixlozone and the non-encapsulated bixlozone are present in a ratio in the range of from about 1:6 to about 6:1.

Embodiment B5. The composition described in Embodiment B4, wherein the encapsulated bixlozone and the non-encapsulated bixlozone are present in a ratio in the range of from about 1:5 to about 5:1.

Embodiment B6. The composition described in Embodiment B5, wherein the encapsulated bixlozone and the non-encapsulated bixlozone are present in a ratio in the range of from about 1:4 to about 4:1.

Embodiment B7. The composition described in Embodiment B6, wherein the encapsulated bixlozone and the non-encapsulated bixlozone are present in a ratio in the range of from about 1:3 to about 3:1.

Embodiment B8. The composition described in Embodiment B7, wherein the encapsulated bixlozone and the non-encapsulated bixlozone are present in a ratio in the range of from about 1:2 to about 2:1.

Embodiment B9. The composition described in Embodiment B6, wherein the encapsulated bixlozone and the non-encapsulated bixlozone are present in a ratio in the range of from about 1:1 to about 1:1.

Embodiment C1. The composition described in the Summary of the Invention, wherein the encapsulated bixlozone is encapsulated with a material selected from synthetic polymers, polyureas, polyurethanes, polyacrylates, polyamides, polyvinyl alcohols, polyvinylpyrrolidones, semi-synthetic materials, modified celluloses, modified starch derivatives, natural materials, gum Arabic, agar agar, dextrins, alginic acid, alginic acid salts, biodegradable natural polymers, collagen, polysaccharides, starch, dextrin, waxes, chitosan, alginate, cellulose, gelatin, derivatives thereof, and combinations thereof.

Embodiment C2. The composition described in Embodiment C1, wherein the encapsulated bixlozone is encapsulated with a material selected from polyurea, a biodegradable natural polymer, chitosan, wax, alginate, cellulose, gelatin, and combinations thereof.

Embodiment C3. The composition described in Embodiment C1, wherein the encapsulated bixlozone is encapsulated with a synthetic polymer.

Embodiment C4. The composition described in Embodiment C3, wherein the encapsulated bixlozone is encapsulated with a polyurea.

Embodiment D1. The composition described in the Summary of the Invention, wherein the additional active ingredient is encapsulated with a material selected from synthetic polymers, polyureas, polyurethanes, polyacrylates, polyamides, polyvinyl alcohols, polyvinylpyrrolidones, semi-synthetic materials, modified celluloses, modified starch derivatives, natural materials, gum Arabic, agar agar, dextrins, alginic acid, alginic acid salts, biodegradable natural polymers, collagen, polysaccharides, starch, dextrin, waxes, chitosan, alginate, cellulose, gelatin, derivatives thereof, and combinations thereof.

Embodiment D2. The composition described in Embodiment D1, wherein the additional active ingredient is encapsulated with a material selected from polyurea, a biodegradable natural polymer, chitosan, wax, alginate, cellulose, gelatin, and combinations thereof.

Embodiment D3. The composition described in Embodiment D1, wherein the additional active ingredient is encapsulated with a synthetic polymer.

Embodiment D4. The composition described in Embodiment D3, wherein the additional active ingredient is encapsulated with a polyurea.

Embodiment E1. The composition described in the Summary of the Invention, wherein the additional active ingredient is selected from beflubutamid, beflubutamid-M, pethoxamid, clomazone, and combinations thereof.

Embodiment E2. The composition described in Embodiment E1, wherein the additional active ingredient is selected from beflubutamid.

Embodiment E3. The composition described in Embodiment E1, wherein the additional active ingredient is selected from beflubutamid-M.

Embodiment E4. The composition described in Embodiment E1, wherein the additional active ingredient is selected from pethoxamid.

Embodiment E5. The composition described in Embodiment E1, wherein the additional active ingredient is selected from clomazone.

Embodiment F1. The composition described in the Summary of the Invention, wherein the encapsulated bixlozone is encapsulated separately from the additional active ingredient.

Embodiment F2. The composition described in the Summary of the Invention, wherein the bixlozone and the additional active ingredient are co-encapsulated.

Embodiment G1. The composition described in the Summary of the Invention, wherein the composition further comprises an auxiliary selected from dispersants, surfactants, biocides, antifoamers, antifreeze agents, rheology modifiers, wetting agents, solvents, salts, and combinations thereof.

Embodiment G2. The composition described in Embodiment G1, wherein the composition further comprises an auxiliary selected from dispersants, surfactants, biocides, antifoamers, antifreeze agents, rheology modifiers, wetting agents, solvents, and combinations thereof.

Embodiment G3. The composition described in Embodiment G1, wherein the composition further comprises a dispersant.

Embodiment G4. The composition described in Embodiment G1, wherein the composition further comprises a surfactant.

Embodiment G5. The composition described in Embodiment G1, wherein the composition further comprises a biocide.

Embodiment G6. The composition described in Embodiment G1, wherein the composition further comprises an antifoamer.

Embodiment G7. The composition described in Embodiment G1, wherein the composition further comprises an antifreeze agent.

Embodiment G8. The composition described in Embodiment G1, wherein the composition further comprises a rheology modifier.

Embodiment G9. The composition described in Embodiment G1, wherein the composition further comprises a wetting agent.

Embodiment G10. The composition described in Embodiment G1, wherein the composition further comprises a solvent.

Embodiment G11. The composition described in Embodiment G1, wherein the composition further comprises a salt.

Embodiment G12. The composition described in Embodiment G10, wherein the composition further comprises a salt selected from sodium nitrate, calcium chloride, and combinations thereof.

Embodiment G13. The composition described in Embodiment G1, wherein the composition further comprises two or more auxiliaries.

Embodiment G14. The composition described in Embodiment G1, wherein the composition further comprises three or more auxiliaries.

Embodiment G15. The composition described in Embodiment G1, wherein the composition further comprises four or more auxiliaries.

Embodiment H1. The composition described in the Summary of the Invention, wherein the composition is in a form selected from a premix and a tank mix.

Embodiment H2. The composition described in Embodiment H1, wherein the composition is a premix.

Embodiment H3. The composition described in Embodiment H1, wherein the composition is a tank mix.

The composition embodiments of this disclosure may be combined with the methods of preparation embodiments of this disclosure in any manner. Similarly, the methods of preparation embodiments of this disclosure may be combined in any manner. The following embodiments are, therefore, to be construed as merely illustrative, and not limiting of the disclosure in any way whatsoever.

Methods of preparation embodiments of the present disclosure include:

Embodiment I1. The method of preparing a composition described in the Summary of the Invention, wherein the encapsulated bixlozone is encapsulated with a material selected from synthetic polymers, polyureas, polyurethanes, polyacrylates, polyamides, polyvinyl alcohols, polyvinylpyrrolidones, semi-synthetic materials, modified celluloses, modified starch derivatives, natural materials, gum Arabic, agar agar, dextrins, alginic acid, alginic acid salts, biodegradable natural polymers, collagen, polysaccharides, starch, dextrin, waxes, chitosan, alginate, cellulose, gelatin, derivatives thereof, and combinations thereof.

Embodiment I2. The method of preparing a composition described in Embodiment I1, wherein the encapsulated bixlozone is encapsulated with a material selected from polyurea, a biodegradable natural polymer, chitosan, wax, alginate, cellulose, gelatin, and combinations thereof.

Embodiment I3. The method of preparing a composition described in Embodiment I1, wherein the encapsulated bixlozone is encapsulated with a synthetic polymer.

Embodiment I4. The method of preparing a composition described in Embodiment I3, wherein the encapsulated bixlozone is encapsulated with a polyurea.

Embodiment J1. The method of preparing a composition described in the Summary of the Invention, further comprising encapsulating the additional active ingredient before forming the mixture.

Embodiment K1. The method of preparing a composition described in the Summary of the Invention, wherein the additional active ingredient is encapsulated with a material selected from synthetic polymers, polyureas, polyurethanes, polyacrylates, polyamides, polyvinyl alcohols, polyvinylpyrrolidones, semi-synthetic materials, modified celluloses, modified starch derivatives, natural materials, gum Arabic, agar agar, dextrins, alginic acid, alginic acid salts, biodegradable natural polymers, collagen, polysaccharides, starch, dextrin, waxes, chitosan, alginate, cellulose, gelatin, derivatives thereof, and combinations thereof.

Embodiment K2. The method of preparing a composition described in Embodiment K1, wherein the additional active ingredient is encapsulated with a material selected from polyurea, a biodegradable natural polymer, chitosan, wax, alginate, cellulose, gelatin, and combinations thereof.

Embodiment K3. The method of preparing a composition described in Embodiment K1, wherein the additional active ingredient is encapsulated with a synthetic polymer.

Embodiment K4. The method of preparing a composition described in Embodiment K3, wherein the additional active ingredient is encapsulated with a polyurea.

Embodiment L1. The method of preparing a composition described in the Summary of the Invention, wherein the encapsulated bixlozone is encapsulated separately from the additional active ingredient.

Embodiment L2. The method of preparing a composition described in the Summary of the Invention, wherein the bixlozone and the additional active ingredient are co-encapsulated.

Embodiment L3. The method of preparing a composition described in Embodiment L2, wherein the bixlozone and the additional active ingredient are co-encapsulated within the same capsules.

Embodiment L4. The method of preparing a composition described in Embodiment L2, wherein the bixlozone and the additional active ingredient are co-encapsulated in a mixture of different capsules.

The composition embodiments of this disclosure may be combined with the methods for controlling undesirable vegetation embodiments of this disclosure in any manner. Similarly, the methods of preparation embodiments of this disclosure may be combined with the methods for controlling undesirable vegetation embodiments of this disclosure in any manner. Similarly, the methods for controlling undesirable vegetation embodiments of this disclosure may be combined in any manner. The following embodiments are, therefore, to be construed as merely illustrative, and not limiting of the disclosure in any way whatsoever.

Methods for controlling undesirable vegetation embodiments of the present disclosure include:

Embodiment M1. The method for controlling undesirable vegetation described in the Summary of the Invention, wherein the undesirable vegetation comprises at least one herbicide-resistant or herbicide-tolerant weed species.

Embodiment M2. The method for controlling undesirable vegetation described in the Summary of the Invention, wherein the undesirable vegetation comprises a broad leaf weed or a grass weed.

Embodiment M3 The method for controlling undesirable vegetation described in Embodiment M2, wherein the undesirable vegetation is selected from Abutilon theophrasti (ABUTH), Acalypha virginica (ACCVI), Alopecurus myosuroides (ALOMY), Amaranthus retroflexus (AMARE), Ambrosia artemisiifolia (AMBEL), Anagallis arvensis (ANGAR), Apera spica-venti (APESV), Arrhenatherum elatius (ARREB), Calystegia sepium (CAGSE), Capsella bursa-pastoris (CAPBP), Centaurea cyamis (CENCY), Chenopodium album (CHEAL), Chenopodium hybridum (CHEHY), Chenopodium polyspermum (CHEPO), Convolvulus arvensis (CONAR), Cynodon dactylon (CYNDA), Cyperus difformis (CYPDI), Cyperus iria (CYPIR), Datura stramonium (DATST), Daucus carota (DAUCA), Descurainia sophia (DESSO), Digitaria sanguinalis (DIGSA), Echinochloa crus-galli (ECHCG), Echinochloa colonum (ECHCO), Fumaria officinalis (FUMOF), Galium aparine (GALAP), Galinsoga quadriradiata (GASCI), Geranium dissectum (GERDI), Geranium mole (GERMO), Geranium pusillum (GERPU), Hibiscus trionum (HIBTR), Lamium amplexicaule (LAMAM), Lamium purpureum (LAMPU), Buglossoides arvensis (LITAR), Lolium multiflorum (LOLMU), Lolium perenne (LOLPE), Lolium rigidum (LOLRI), Matricaria chamomilla (MATCH), Tripleurospermum modorum (MATIN), Mercurialis anna (MERAN), Panicum dichotomiflorum (PANDI), Panicion miliaceum (PANMI), Papaver rhoeas (PAPRH), Phalaris minor (PHAMI), Poa annua (POAAN), Polygonum aviculare (POLAV), Fallopia convolvulus (POLCO), Persicaria hydropiper (POLHY), Persicaria lapathifolia (POLLA), Persicaria maculosa (POLPE), Portulaca oleracea (POROL), Potentilla tridentate (PTLTR), Senecio vulgaris (SENVU), Setaria pumila (SETPU), Setaria viridis (SETVI), Solanum nigrum (SOLNI), Sorghum halepense (SORHA), Stellaria media (STEME), Trifolium incarnatum (TRFIN), Veronica arvensis (VERAR), Veronica hederifolia (VERHE), Veronica persica (VERPE), Viola arvensis (VIOAR), and Xanthium strumarium (XANST), and combinations thereof.

Embodiment M4. The method for controlling undesirable vegetation described in Embodiment M3, wherein the undesirable vegetation is Abutilon theophrasti (ABUTH).

Embodiment M5. The method for controlling undesirable vegetation described in Embodiment M3, wherein the undesirable vegetation is Acalypha virginica (ACCVI).

Embodiment M6. The method for controlling undesirable vegetation described in Embodiment M3, wherein the undesirable vegetation is Alopecurus myosuroides (ALOMY).

Embodiment M7. The method for controlling undesirable vegetation described in Embodiment M3, wherein the undesirable vegetation is Amaranthus retroflexus (AMARE).

Embodiment M8. The method for controlling undesirable vegetation described in Embodiment M3, wherein the undesirable vegetation is Ambrosia artemisiifolia (AMBEL).

Embodiment M9. The method for controlling undesirable vegetation described in Embodiment M3, wherein the undesirable vegetation is Anagallis arvensis (ANGAR).

Embodiment M10. The method for controlling undesirable vegetation described in Embodiment M3, wherein the undesirable vegetation is Apera spica-venti (APESV).

Embodiment M11. The method for controlling undesirable vegetation described in Embodiment M3, wherein the undesirable vegetation is Arrhenatherum elatius (ARREB).

Embodiment M12. The method for controlling undesirable vegetation described in Embodiment M3, wherein the undesirable vegetation is Calystegia sepium (CAGSE).

Embodiment M13. The method for controlling undesirable vegetation described in Embodiment M3, wherein the undesirable vegetation is Capsella bursa-pastoris (CAPBP).

Embodiment M14. The method for controlling undesirable vegetation described in Embodiment M3, wherein the undesirable vegetation is Centaurea cyamis (CENCY).

Embodiment M15. The method for controlling undesirable vegetation described in Embodiment M3, wherein the undesirable vegetation is Chenopodium album (CHEAL).

Embodiment M16. The method for controlling undesirable vegetation described in Embodiment M3, wherein the undesirable vegetation is Chenopodium hybridum (CHEHY).

Embodiment M17. The method for controlling undesirable vegetation described in Embodiment M3, wherein the undesirable vegetation is Chenopodium polyspermum (CHEPO).

Embodiment M18. The method for controlling undesirable vegetation described in Embodiment M3, wherein the undesirable vegetation is Convolvulus arvensis (CONAR).

Embodiment M19. The method for controlling undesirable vegetation described in Embodiment M3, wherein the undesirable vegetation is Cynodon dactylon (CYNDA).

Embodiment M20. The method for controlling undesirable vegetation described in Embodiment M3, wherein the undesirable vegetation is Cyperus difformis (CYPDI).

Embodiment M21. The method for controlling undesirable vegetation described in Embodiment M3, wherein the undesirable vegetation is Cyperus iria (CYPIR).

Embodiment M22. The method for controlling undesirable vegetation described in Embodiment M3, wherein the undesirable vegetation is Datura stramonium (DATST).

Embodiment M23. The method for controlling undesirable vegetation described in Embodiment M3, wherein the undesirable vegetation is Daucus carota (DAUCA).

Embodiment M24. The method for controlling undesirable vegetation described in Embodiment M3, wherein the undesirable vegetation is Descurainia sophia (DESSO).

Embodiment M25. The method for controlling undesirable vegetation described in Embodiment M3, wherein the undesirable vegetation is Digitaria sanguinalis (DIGSA).

Embodiment M26. The method for controlling undesirable vegetation described in Embodiment M3, wherein the undesirable vegetation is Echinochloa crus-galli (ECHCG).

Embodiment M27. The method for controlling undesirable vegetation described in Embodiment M3, wherein the undesirable vegetation is Echinochloa colonum (ECHCO).

Embodiment M28. The method for controlling undesirable vegetation described in Embodiment M3, wherein the undesirable vegetation is Fumaria officinalis (FUMOF).

Embodiment M29. The method for controlling undesirable vegetation described in Embodiment M3, wherein the undesirable vegetation is Galium aparine (GALAP).

Embodiment M30. The method for controlling undesirable vegetation described in Embodiment M3, wherein the undesirable vegetation is Galinsoga quadriradiata (GASCI).

Embodiment M31. The method for controlling undesirable vegetation described in Embodiment M3, wherein the undesirable vegetation is Geranium dissectum (GERDI).

Embodiment M32. The method for controlling undesirable vegetation described in Embodiment M3, wherein the undesirable vegetation is Geranium mole (GERMO).

Embodiment M33. The method for controlling undesirable vegetation described in Embodiment M3, wherein the undesirable vegetation is Geranium pusillum (GERPU).

Embodiment M34. The method for controlling undesirable vegetation described in Embodiment M3, wherein the undesirable vegetation is Hibiscus trionum (HIBTR).

Embodiment M35. The method for controlling undesirable vegetation described in Embodiment M3, wherein the undesirable vegetation is Lamium amplexicaule (LAMAM).

Embodiment M36. The method for controlling undesirable vegetation described in Embodiment M3, wherein the undesirable vegetation is Lamium purpureum (LAMPU).

Embodiment M37. The method for controlling undesirable vegetation described in Embodiment M3, wherein the undesirable vegetation is Buglossoides arvensis (LITAR).

Embodiment M38. The method for controlling undesirable vegetation described in Embodiment M3, wherein the undesirable vegetation is Lolium multiflorum (LOLMU).

Embodiment M39. The method for controlling undesirable vegetation described in Embodiment M3, wherein the undesirable vegetation is Lolium perenne (LOLPE).

Embodiment M40. The method for controlling undesirable vegetation described in Embodiment M3, wherein the undesirable vegetation is Lolium rigidum (LOLRI).

Embodiment M41. The method for controlling undesirable vegetation described in Embodiment M3, wherein the undesirable vegetation is Matricaria chamomilla (MATCH).

Embodiment M42. The method for controlling undesirable vegetation described in Embodiment M3, wherein the undesirable vegetation is Tripleurospermum inodorum (MATIN).

Embodiment M43. The method for controlling undesirable vegetation described in Embodiment M3, wherein the undesirable vegetation is Mercurialis annua (MERAN).

Embodiment M44. The method for controlling undesirable vegetation described in Embodiment M3, wherein the undesirable vegetation is Panicum dichotomiflorum (PANDI).

Embodiment M45. The method for controlling undesirable vegetation described in Embodiment M3, wherein the undesirable vegetation is Panicum miliaceum (PANMI).

Embodiment M46. The method for controlling undesirable vegetation described in Embodiment M3, wherein the undesirable vegetation is Papaver rhoeas (PAPRH).

Embodiment M47. The method for controlling undesirable vegetation described in Embodiment M3, wherein the undesirable vegetation is Phalaris minor (PHAMI).

Embodiment M48. The method for controlling undesirable vegetation described in Embodiment M3, wherein the undesirable vegetation is Poa annua (POAAN).

Embodiment M49. The method for controlling undesirable vegetation described in Embodiment M3, wherein the undesirable vegetation is Polygonum aviculare (POLAV).

Embodiment M50. The method for controlling undesirable vegetation described in Embodiment M3, wherein the undesirable vegetation is Fallopia convolvulus (POLCO).

Embodiment M51. The method for controlling undesirable vegetation described in Embodiment M3, wherein the undesirable vegetation is Persicaria hydropiper (POLHY).

Embodiment M52. The method for controlling undesirable vegetation described in Embodiment M3, wherein the undesirable vegetation is Persicaria lapathifolia (POLLA).

Embodiment M53. The method for controlling undesirable vegetation described in Embodiment M3, wherein the undesirable vegetation is Persicaria maculosa (POLPE).

Embodiment M54. The method for controlling undesirable vegetation described in Embodiment M3, wherein the undesirable vegetation is Portulaca oleracea (POROL).

Embodiment M55. The method for controlling undesirable vegetation described in Embodiment M3, wherein the undesirable vegetation is Potentilla tridentate (PTLTR).

Embodiment M56. The method for controlling undesirable vegetation described in Embodiment M3, wherein the undesirable vegetation is Senecio vulgaris (SENVU).

Embodiment M57. The method for controlling undesirable vegetation described in Embodiment M3, wherein the undesirable vegetation is Setaria pumila (SETPU).

Embodiment M58. The method for controlling undesirable vegetation described in Embodiment M3, wherein the undesirable vegetation is Setaria viridis (SETVI).

Embodiment M59. The method for controlling undesirable vegetation described in Embodiment M3, wherein the undesirable vegetation is Solanum nigrum (SOLNI).

Embodiment M60. The method for controlling undesirable vegetation described in Embodiment M3, wherein the undesirable vegetation is Sorghum halepense (SORHA).

Embodiment M61. The method for controlling undesirable vegetation described in Embodiment M3, wherein the undesirable vegetation is Stellaria media (STEME).

Embodiment M62. The method for controlling undesirable vegetation described in Embodiment M3, wherein the undesirable vegetation is Trifolium incarnatum (TRFIN).

Embodiment M63. The method for controlling undesirable vegetation described in Embodiment M3, wherein the undesirable vegetation is Veronica arvensis (VERAR).

Embodiment M64. The method for controlling undesirable vegetation described in Embodiment M3, wherein the undesirable vegetation is Veronica hederifolia (VERHE).

Embodiment M65. The method for controlling undesirable vegetation described in Embodiment M3, wherein the undesirable vegetation is Veronica persica (VERPE).

Embodiment M66. The method for controlling undesirable vegetation described in Embodiment M3, wherein the undesirable vegetation is Viola arvensis (VIOAR).

Embodiment M67. The method for controlling undesirable vegetation described in Embodiment M3, wherein the undesirable vegetation is Xanthium strumarium (XANST).

Embodiment M68. The method for controlling undesirable vegetation described in the Summary of the Invention, wherein the undesirable vegetation is selected from annual blue grass, annual ryegrass (Lolium rigidum), ball medic (Medicago spp.), barley grass (Hordeum murinum), bedstraw (Galium tricornutum), Benghal dayflower, bifora (Bifora testiculata), black grass, black night shade, broadleaf signal grass, brome grass (Bromus spp.), Canada thistle, capeweed (Arctotheca calendula), cheat, chickweed (Stellaria media), common cocklebur (Xanthium pensylvanicum), common ragweed, corn poppies, doublegee (Emex australis), field violet, fleabane (Conyza bonariensis) giant foxtail, fumitory (Fumaria spp), goose grass, green fox tail, guinea grass, hairy beggarticks, herbicide-resistant black grass, horseweed, Indian hedge mustard (Sisymbrium orientale), Italian rye grass, Jersey cudweed (Gnaphalium luteoalbum), jimsonweed, johnsongrass (Sorghum halepense), large crabgrass, lesser loosestrife (Lythrum hyssopifolia), little seed cany grass, morning glory, Patterson's Curse (Echium plantagineum), Pennsylvania smartweed, phalaris (Phalaris paradoxa), pitted morningglory, prickly lettuce (Lactuca serriola), prickly sida, quack grass, redflowered mallow (Modiola caroliniana), redroot pigweed, rough poppy (Papaver hybridum), serradella, shatter cane, shepherd's purse, silky windgrass, silvergrass (Vulpia bromoides), sowthistle (Sonchus oleraceus), sub-clover (Trifolium spp.), sunflower (as weed in potato), volunteer chickpea, faba beans, field peas, lentils, lupins and vetch, wild buckwheat (Polygonum convolvulus), wild mustard (Brassica kaber), wild oat (Avena fatua), wild poinsettia, wild radish (Raphanus raphanistrum), wild turnip (Rapistrum rugosum, Brassica tournefortii), wireweed (Polygonum aviculare), yellow foxtail, yellow nutsedge (Cyperus esculentus).

Embodiment M69. The method of Embodiment M68 wherein the undesired vegetation is selected from wild radish (Raphanus raphanistrum), velvetleaf, jimsonweed, common cocklebur and hairy beggarticks.

Embodiment M70. The method of Embodiment M68 wherein the undesired vegetation is wild radish (Raphanus raphanistrum).

Embodiment N1. The method for controlling undesirable vegetation described in the Summary of the Invention, wherein the composition is applied at a stage selected from pre-emergence, post-emergence, and combinations thereof.

Embodiment N2. The method for controlling undesirable vegetation described in Embodiment N1, wherein the composition is applied at pre-emergence.

Embodiment N3. The method for controlling undesirable vegetation described in Embodiment N1, wherein the composition is applied at post-emergence.

Embodiment N4. The method for controlling undesirable vegetation described in Embodiment N1, wherein the composition is applied at pre-emergence and post-emergence.

Generally, compositions in accordance with the present disclosure comprise encapsulated bixlozone and non-encapsulated bixlozone in an effective amount. An effective amount of encapsulated bixlozone and non-encapsulated bixlozone is any amount that has the ability to combat the harmful plants while providing acceptable safety in the absence of a safener. The effectiveness of said compositions used in methods for the control of harmful plants will depend on various factors such as the mode of application, the harmful plants to be combated, the useful plant to be protected, the application time, etc. Methods of using of said effective compositions can be readily determined by the skilled person using well known principles.

In many embodiments, encapsulated bixlozone and non-encapsulated bixlozone are present and/or applied in a ratio of encapsulated bixlozone and non-encapsulated bixlozone that is an effective amount. The ratio may be a weight ratio, a molar ratio, an application rate ratio, or a volume ratio. The ratio is preferably an application rate ratio. As used herein, the effective application ratio is effective on target weeds and is also safe to the crop.

In some embodiments, encapsulated bixlozone is employed in an amount of from about 1 g/ha, about 10 g/ha, about 50 g/ha, about 100 g/ha, about 200 g/ha, about 300 g/ha, about 400 g/ha, about 500 g/ha, about 600 g/ha, about 700 g/ha, about 800 g/ha, about 900 g/ha, about 1000 g/ha, about 1100 g/ha, about 1200 g/ha, about 1300 g/ha, about 1400 g/ha, about 1500 g/ha, about 1600 g/ha, about 1700 g/ha, about 1800 g/ha, about 1900 g/ha, about 2000 g/ha, about 2100 g/ha, about 2200 g/ha, about 2300 g/ha, about 2400 g/ha, about 2500 g/ha, about 2600 g/ha, about 2700 g/ha, about 2800 g/ha, about 2900 g/ha, about 3000 g/ha, or greater than about 3000 g/ha, to about 10 g/ha, about 50 g/ha, about 100 g/ha, about 200 g/ha, about 300 g/ha, about 400 g/ha, about 500 g/ha, about 600 g/ha, about 700 g/ha, about 800 g/ha, about 900 g/ha, about 1000 g/ha, about 1100 g/ha, about 1200 g/ha, about 1300 g/ha, about 1400 g/ha, about 1500 g/ha, about 1600 g/ha, about 1700 g/ha, about 1800 g/ha, about 1900 g/ha, about 2000 g/ha, about 2100 g/ha, about 2200 g/ha, about 2300 g/ha, about 2400 g/ha, about 2500 g/ha, about 2600 g/ha, about 2700 g/ha, about 2800 g/ha, about 2900 g/ha, about 3000 g/ha, or greater than about 3000 g/ha. However, higher and lower doses may also provide adequate control.

In some embodiments, non-encapsulated bixlozone is employed in an amount of from about 1 g/ha, about 10 g/ha, about 50 g/ha, about 100 g/ha, about 200 g/ha, about 300 g/ha, about 400 g/ha, about 500 g/ha, about 600 g/ha, about 700 g/ha, about 800 g/ha, about 900 g/ha, about 1000 g/ha, about 1100 g/ha, about 1200 g/ha, about 1300 g/ha, about 1400 g/ha, about 1500 g/ha, about 1600 g/ha, about 1700 g/ha, about 1800 g/ha, about 1900 g/ha, about 2000 g/ha, about 2100 g/ha, about 2200 g/ha, about 2300 g/ha, about 2400 g/ha, about 2500 g/ha, about 2600 g/ha, about 2700 g/ha, about 2800 g/ha, about 2900 g/ha, about 3000 g/ha, or greater than about 3000 g/ha, to about 10 g/ha, about 50 g/ha, about 100 g/ha, about 200 g/ha, about 300 g/ha, about 400 g/ha, about 500 g/ha, about 600 g/ha, about 700 g/ha, about 800 g/ha, about 900 g/ha, about 1000 g/ha, about 1100 g/ha, about 1200 g/ha, about 1300 g/ha, about 1400 g/ha, about 1500 g/ha, about 1600 g/ha, about 1700 g/ha, about 1800 g/ha, about 1900 g/ha, about 2000 g/ha, about 2100 g/ha, about 2200 g/ha, about 2300 g/ha, about 2400 g/ha, about 2500 g/ha, about 2600 g/ha, about 2700 g/ha, about 2800 g/ha, about 2900 g/ha, about 3000 g/ha, or greater than about 3000 g/ha. However, higher and lower doses may also provide adequate control.

Rates of application of the compositions will vary according to prevailing conditions such as targeted weeds, degree of infestation, weather conditions, soil conditions, crop species, mode of application, and application time. Compositions containing the active compounds may be applied in the form in which they are formulated. In practice of the present disclosure, such as when a formulator prepares a formulation, rates of application of encapsulated bixlozone and non-encapsulated bixlozone can be varied independent of each other, provided that each of the components are applied within the disclosed limits of the present disclosure.

Compositions according to the present disclosure may be in any suitable form of agrochemical compositions known in the art. Particularly preferred formulations of compositions in accordance with the present disclosure are mixtures of suspension concentrates (SC) and capsule suspension concentrates (CS) formulations (ZC). The acronym “SC” means suspension concentrate (a stable suspension of active ingredient(s) with water as the fluid); “ZC” refers to a mixed formulation of CS and SC (a stable suspension of capsules and active ingredient(s) in a fluid, normally intended for dilution with water before use).

The agrochemical compositions may be applied in various combinations of the two active compounds. For example, they may be applied as a single “pre-mix” form, or in a combined spray mixture composed from separate formulations of the active compounds, e.g., a “tank-mix” form. Thus, to be used in combination, it is not necessary that the two active compounds be applied in a physically combined form, or even at the same time, i.e. the components may be applied in a separately and/or sequentially application, provided that the application of the second active compound occurs within a reasonable period of time from the application of the first active compound. The combination effect results so long as the two active compounds are present at the same time, regardless of when they were applied. Thus, for instance, a physical combination of the two active compounds could be applied, or one could be applied earlier than the other so long as the earlier-applied active compound is still present on the harmful plant to be controlled or in the soil surrounding the harmful plant to be controlled when the second active compound is applied, and so long as the weight ratio of available active compounds falls within that provided herein. The order of applying the individual components encapsulated bixlozone and non-encapsulated bixlozone is not essential. Likewise, any form of combination of the active components may be applied for either pre- or post-emergence control of harmful plants, e.g., weeds in crops of useful plants.

Compositions in accordance with the present disclosure may be formulated with further suitable formulation components known in the art. As non-limiting examples, compositions in accordance with the present disclosure may be formulated using known auxiliaries, adjuvants, diluents, solvents, dispersants, surfactants, protective colloids, thickeners, penetrating agents, stabilizers, sequestering agents, anti-caking agents, coloring agents, pigments, corrosion inhibitors, biocides, antifoamers, antifreeze agents, rheology modifiers, and combinations thereof.

The term surfactant, as used herein, means an agriculturally acceptable material which imparts emulsifiability, stability, spreading, wetting, dispersibility or other surface-modifying properties. Examples of suitable surfactants include lignin sulfonates, fatty acid sulfonates (e.g., lauryl sulfonate), the condensation product of formaldehyde with naphthalene sulfonate, alkylarylsulfonates, ethoxylated alkylphenols, and ethoxylated fatty alcohols. Other known surfactants that have been used with herbicides are also acceptable.

Suitable diluents may be added during the formulation process, after the formulation process (e.g., by the user—a farmer or custom applicator), or both. The term diluent includes all liquid and solid agriculturally acceptable material-including carriers which may be added to the herbicides to bring them in a suitable application or commercial form and include solvents, emulsifiers, and dispersants. Examples of suitable solid diluents or carriers are aluminum silicate, talc, calcined magnesia, kieselguhr, tricalcium phosphate, powdered cork, absorbent carbon black, chalk, silica, and clays such as kaolin and bentonite. Examples of suitable liquid diluents include water, organic solvents (e.g., acetophenone, cyclohexanone, isophorone, toluene, xylene, petroleum distillates), amines (e.g., ethanolamine, dimethylformamide), and mineral, animal, and vegetable oils (used alone or in combination).

Compositions in accordance with the present disclosure may also be formulated with further suitable additional active ingredients known in the art. An additional herbicide may be utilized if broadening of the spectrum of control or preventing the build-up of resistance is desired.

Examples of additional active ingredients are acetochlor, acifluorfen and its sodium salt, aclonifen, acrolein (2-propenal), alachlor, alloxydim, ametryn, amicarbazone, amidosulfuron, aminocyclopyrachlor and its esters (e.g., methyl, ethyl) and salts (e.g., sodium, potassium), aminopyralid, amitrole, ammonium sulfamate, anilofos, asulam, atrazine, azimsulfuron, beflubutamid, beflubutamid-M, benazolin, benazolin-ethyl, bencarbazone, benfluralin, benfuresate, benquinotrione, bensulfuron-methyl, bensulide, bentazone, benzobicyclon, benzofenap, bicyclopyrone, bifenox, bilanafos, bipyrazone, bispyribac and its sodium salt, broclozone, bromacil, bromobutide, bromofenoxim, bromoxynil, bromoxynil octanoate, butachlor, butafenacil, butamifos, butralin, butroxydim, butylate, cafenstrole, carbetamide, carfentrazone-ethyl, catechin, chlomethoxyfen, chloramben, chlorbromuron, chlorflurenol-methyl, chloridazon, chlorimuron-ethyl, chlorotoluron, chlorpropham, chlorsulfuron, chlorthal-dimethyl, chlorthiamid, cinidon-ethyl, cinmethylin, cinosulfuron, clacyfos, clefoxydim, clethodim, clodinafop-propargyl, clomazone, clomeprop, clopyralid, clopyralid-olamine, cloransulam-methyl, cumyluron, cyanazine, cycloate, cyclopyranil, cyclopyrimorate, cyclosulfamuron, cycloxydim, cyhalofop-butyl, cypyrafluone, 2,4-D and its butotyl, butyl, isoctyl and isopropyl esters and its dimethylammonium, diolamine and trolamine salts, daimuron, dalapon, dalapon-sodium, dazomet, 2,4-DB and its dimethylammonium, potassium and sodium salts, desmedipham, desmetryn, dicamba and its diglycolammonium, dimethylammonium, potassium and sodium salts, dichlobenil, dichlorprop, diclofop-methyl, diclosulam, difenzoquat metilsulfate, diflufenican, diflufenzopyr, dimefuron, dimesulfazet, dimepiperate, dimesulfazet, dimethachlor, dimethametryn, dimethenamid, dimethenamid-P, dimethipin, dimethylarsinic acid and its sodium salt, dinitramine, dinoterb, dioxopyritrione, diphenamid, diquat dibromide, dithiopyr, diuron, DNOC, endothal, EPTC, epyrifenacil, esprocarb, ethalfluralin, ethametsulfuron-methyl, ethiozin, ethofumesate, ethoxyfen, ethoxysulfuron, etobenzanid, fenoxaprop-ethyl, fenoxaprop-P-ethyl, fenoxasulfone, fenpyrazone, fenquinotrione, fentrazamide, fenuron, fenuron-TCA, flamprop-methyl, flamprop-M-isopropyl, flamprop-M-methyl, flazasulfuron, florasulam, fluazifop-butyl, fluazifop-P-butyl, fluazolate, flucarbazone, flucetosulfuron, fluchloralin, fluchloraminopyr, flufenacet, flufenoximacil, flufenpyr, flufenpyr-ethyl, flumetsulam, flumiclorac-pentyl, flumioxazin, fluometuron, fluoroglycofen-ethyl, flupoxam, flupyrsulfuron-methyl and its sodium salt, flurenol, flurenol-butyl, fluridone, flurochloridone, fluroxypyr, flurtamone, flusulfinam, fluthiacet-methyl, fomesafen, foramsulfuron, fosamine-ammonium, glufosinate, glufosinate-ammonium, L-glufosinate-ammonium, glufosinate-P, glyphosate and its salts such as ammonium, isopropylammonium, potassium, sodium (including sesquisodium) and trimesium (alternatively named sulfosate), halauxifen, halauxifen-methyl, halosulfuron-methyl, haloxyfop-etotyl, haloxyfop-methyl, hexazinone, hydantocidin, icafolin, imazamethabenz-methyl, imazamox, imazapic, imazapyr, imazaquin, imazaquin-ammonium, imazethapyr, imazethapyr-ammonium, imazosulfuron, indanofan, indaziflam, indolauxipyr, iofensulfuron, iodosulfuron-methyl, ioxynil, ioxynil octanoate, ioxynil-sodium, ipfencarbazone, iptriazopyrid, isoproturon, isouron, isoxaben, isoxaflutole, isoxachlortole, lactofen, lancotrione, lenacil, linuron, maleic hydrazide, MCPA and its salts (e.g., MCPA-dimethylammonium, MCPA-potassium and MCPA-sodium, esters (e.g., MCPA-2-ethylhexyl, MCPA-butotyl) and thioesters (e.g., MCPA-thioethyl), MCPB and its salts (e.g., MCPB-sodium) and esters (e.g., MCPB-ethyl), mecoprop, mecoprop-P, mefenacet, mefluidide, mesosulfuron-methyl, mesotrione, metam-sodium, metamifop, metamitron, metazachlor, metazosulfuron, methabenzthiazuron, methylarsonic acid and its calcium, monoammonium, monosodium and disodium salts, methyldymron, metobenzuron, metobromuron, metolachlor, S-metolachlor, metosulam, metoxuron, metproxybicyclone, metribuzin, metsulfuron-methyl, molinate, monolinuron, naproanilide, napropamide, napropamide-M, naptalam, neburon, nicosulfuron, norflurazon, orbencarb, orthosulfamuron, oryzalin, oxadiargyl, oxadiazon, oxasulfuron, oxaziclomefone, oxyfluorfen, paraquat dichloride, pebulate, pelargonic acid, pendimethalin, penoxsulam, pentanochlor, pentoxazone, perfluidone, pethoxamid, pethoxyamid, phenmedipham, picloram, picloram-potassium, picolinafen, pinoxaden, piperophos, pretilachlor, primisulfuron-methyl, prodiamine, profoxydim, prometon, prometryn, propachlor, propanil, propaquizafop, propazine, propham, propisochlor, propoxycarbazone, propyrisulfuron, propyzamide, prosulfocarb, prosulfuron, pyraclonil, pyraflufen-ethyl, pyrasulfotole, pyrazogyl, pyrazolynate, pyrazoxyfen, pyrazosulfuron-ethyl, pyribenzoxim, pyributicarb, pyridate, pyriflubenzoxim, pyriftalid, pyriminobac-methyl, pyrimisulfan, pyrithiobac, pyrithiobac-sodium, pyroxasulfone, pyroxsulam, quinclorac, quinmerac, quinoclamine, quizalofop-ethyl, quizalofop-P-ethyl, quizalofop-P-tefuryl, rimisoxafen, rimsulfuron, saflufenacil, sethoxydim, siduron, simazine, simetryn, sulcotrione, sulfentrazone, sulfometuron-methyl, sulfosulfuron, 2,3,6-TBA, TCA, TCA-sodium, tebutam, tebuthiuron, tefuryltrione, tembotrione, tepraloxydim, terbacil, terbumeton, terbuthylazine, terbutryn, tetflupyrolimet, thenylchlor, thiazopyr, thiencarbazone, thifensulfuron-methyl, thiobencarb, tiafenacil, tiocarbazil, tolpyralate, topramezone, tralkoxydim, tri-allate, triafamone, triasulfuron, triaziflam, tribenuron-methyl, triclopyr, triclopyr-butotyl, triclopyr-triethylammonium, tridiphane, trietazine, trifloxysulfuron, trifludimoxazin, trifluralin, triflusulfuron-methyl, tripyrasulfone, tritosulfuron, vernolate, 3-(2-chloro-3,6-difluorophenyl)-4-hydroxy-1-methyl-1,5-naphthyridin-2 (1H)-one, 6-chloro-4-(2,7-dimethyl-1-naphthalenyl)-5-hydroxy-2-methyl-3 (2H)-pyridazinone, 5-chloro-3-[(2-hydroxy-6-oxo-1-cyclohexen-1-yl)carbonyl]-1-(4-methoxyphenyl)-2 (1H)-quinoxalinone, 2-chloro-N-(1-methyl-1H-tetrazol-5-yl)-6-(trifluoromethyl)-3-pyridinecarboxamide, 7-(3,5-dichloro-4-pyridinyl)-5-(2,2-difluoroethyl)-8-hydroxypyrido[2,3-b]pyrazin-6 (5H)-one), 4-(2,6-diethyl-4-methylphenyl)-5-hydroxy-2,6-dimethyl-3 (2/1)-pyridazinone), 5-[[(2,6-difluorophenyl)methoxy]methyl]-4,5-dihydro-5-methyl-3-(3-methyl-2-thienyl) isoxazole (previously methioxolin), 4-(4-fluorophenyl)-6-[(2-hydroxy-6-oxo-1-cyclohexen-1-yl)carbonyl]-2-methyl-1,2,4-triazine-3,5 (2H,4H)-dione, methyl 4-amino-3-chloro-6-(4-chloro-2-fluoro-3-methoxyphenyl)-5-fluoro-2-pyridinecarboxylate, 2-methyl-3-(methylsulfonyl)-N-(1-methyl-1H-tetrazol-5-yl)-4-(trifluoromethyl)benzamide and 2-methyl-N-(4-methyl-1,2,5-oxadiazol-3-yl)-3-(methylsulfinyl)-4-(trifluoromethyl)benzamide. Other herbicides also include bioherbicides such as Alternaria destruens Simmons, Colletotrichum gloeosporiodes (Penz.) Penz. & Sacc., Drechsiera monoceras (MTB-951), Myrothecium verrucaria (Albertini & Schweinitz) Ditmar: Fries, Phytophthora palmivora (Butl.) Butl. and Puccinia thlaspeos Schub, their environmentally compatible salts, “acids”, esters and amides, and combinations thereof.

Any of the water-soluble salts are appropriate in this formulation. Examples of appropriate salts are common inorganic salts. Appropriate salts are those that are easily water-soluble and that are selected from the group consisting of alkali metal halide, alkaline earth metal halide, ammonium halide, alkali metal sulfate, alkaline earth metal sulfate, ammonium sulfate, alkali metal nitrate, alkaline earth metal nitrate, ammonium nitrate, alkali metal carbonate, and ammonium carbonate. Examples of alkali metal halides include LiCl, LiBr, LiI, NaCl, NaBr, NaI, KF, KCl, KBr, KI, RbF, RbCl, RbBr, and RbI. Examples of alkaline earth metal halides include MgCl₂, MgBr₂, MgI₂, CaCl₂, CaBr₂, CaI₂, SrCl₂, SrBr₂, SrI₂, BaCl₂, BaBr₂, and BaI₂. Examples of ammonium halide include NH₄F, NH₄Cl, NH₄Br, and NH₄I. Examples of alkali metal sulfate are Li₂SO₄, Na₂SO₄, K₂SO₄, and Rb₂SO₄. An example of an alkaline earth metal sulfate is MgSO₄. Ammonium sulfate is (NH₄)₂SO₄. Examples of alkali metal nitrate include LiNO₃, NaNO₃, KNO₃, and RbNO₃. Examples of alkaline earth metal nitrate include Mg(NO₃)₂, Ca(NO₃)₂, and Sr(NO₃)₂. Ammonium nitrate is NH₄NO₃. Examples of alkali metal carbonate include Na₂CO₃, K₂CO₃, and Rb₂CO₃. Ammonium carbonate is (NH₄)₂CO₃.

The compositions according to the present disclosure can be employed for the selective control of grasses and annual and perennial monocotyledonous and dicotyledonous harmful plants the presence of useful plants such as maize, soya, peas, beans, oilseed rape, sugar cane, cassava, pumpkins, potatoes, vegetables, wheat, rice, and tobacco. Within the scope of this invention is also the control of such harmful plants found among transgenic useful plants or among useful plants selected by classical means which are resistant to bixlozone. Likewise, the compositions can be employed for controlling undesirable harmful plants in plantation crops.

Without further elaboration, it is believed that one skilled in the art using the preceding description can utilize the present invention to its fullest extent. The following Examples are, therefore, to be construed as merely illustrative, and not limiting of the disclosure in any way whatsoever.

### EXAMPLES

The invention is illustrated by the following examples.

### Materials.

The following materials are utilized in these examples:

Reax 88B: sodium lignosulfonate dispersant.

Aromatic 200ND: high solvency naphthalene-depleted Cn aromatic fluid.

Kelzan S+: xanthan gum.

Proxel: antibacterial aqueous solution of 1,2-benzisothiazol-3 (2H)-one.

HMDA: hexamethylene diamine.

PAPI 27: polymethylene polyphenylisocyanate that contains methylene diphenyl diisocyanate.

Supragil MNS: condensed methyl naphthalene sulfonate, sodium salt

Xiameter AFE-0100: 30% active silicone emulsion.

Formulation-8: EC-formulation including bixlozone 200 g/L+beflubutamid 125 g/L and cloquintocet-mexyl 34.5 g/L.

Formulation-S: ZC-formulation including bixlozone 200 g/L+beflubutamid 125 g/L and cloquintocet-mexyl 34.5 g/L; Bixlozone encapsulation rate: 75% SC+25% CS; Beflubutamid 100% CS; Cloquintocet as SC.

Formulation-6: ZC-formulation including bixlozone 200 g/L+beflubutamid 125 g/L and cloquintocet-mexyl 34.5 g/L; Bixlozone encapsulation rate; 50% SC+50% CS; Beflubutamid 100% CS; Cloquintocet as SC.

Formulation-7: ZC-formulation including bixlozone 200 g/L+beflubutamid 125 g/L and cloquintocet-mexyl 34.5 g/L; Bixlozone encapsulation rate; 25% SC+75% CS; Beflubutamid 100% CS; Cloquintocet as SC.

BEF: beflubutamid

FFC: Flufenacet

PEN: Pendimethalin

DFF: Diflufenican

MEF: mefenpyr diethyl safener

F4205-11: rate 1.75 L/ha equivalent to 375 g/ha bixlozone+300 g/ha pethoxamid

F4253-03:200 g/L cloquintocet-mexyl SC

$$\begin{matrix}Adengo Xtra = Isoxaflutol + thiencarbazone - methyl + cyprosulfamide , \\ 225 + 90 + 150 g / L SC ; Use rate of 0.44 L / ha brings equivalent of 66 g / ha cyprosulfamide safener\end{matrix}$$

### Example 1. Compositions

Separate encapsulated and non-encapsulated compositions were prepared as follows.

Composition F9600-4 (Bixiozone SC).

TABLE 1
Bixlozone SC composition.

| Component | Wt (%) |
|---|---|
| Bixlozone technical | 35.35 |
| Reax 88B | 2.00 |
| Sodium nitrate | 6.00 |
| Calcium chloride | 6.00 |
| Water | 50.65 |
| Total | 100 |

Composition Bixlozone ZC.

TABLE 2
Bixlozone ZC composition.

| Component | Wt (%) |
|---|---|
| Bixlozone Technical (75% CS and 25% SC) | 35.35 |
| Aromatic 200ND | 6.48 |
| Reax 88B | 1.15 |
| Sodium nitrate | 5.33 |
| Calcium chloride | 5.33 |
| Kelzan S+ | 0.07 |
| Proxel | 0.04 |
| Glacial acetic acid | 0.03 |
| HMDA (43%) | 2.16 |
| PAPI 27 | 2.16 |
| Water | 41.90 |
| Total | 100.00 |

### Example 2. Preparation of Component Compositions

The above compositions were prepared as follows.

Encapsulation of bixlozone

About 30 parts of bixlozone was mixed with 12 parts of Aromatic 200ND and heated to around 60 to 65° C. to completely dissolve the bixlozone in Aromatic 200ND, then 2 parts of PAPI 27 was added. In a separate vessel, 46 parts of water was mixed with 1.15 part of Reax 88B and heated to 65° C. The two solutions were added together and mixed to form a stable emulsion. Then, 2 parts of 43% solution of HMDA was added to the emulsified mass to yield the encapsulated beflubutamid. The solution was then cured at 55° C. for 4 h. After completing the reaction, 2 parts of 2.0% Kelzan S solution was added to increase the viscosity.

Preparation of bixlozone for the SC formulation.

The SC formulation was prepared by wet milling the bixlozone in a media mill until a particle size D90 of less than 10 micron was achieved.

### Example 3. Wind Tunnel Testing

Safety to non-target plants was analyzed for encapsulated and non-encapsulated bixlozone through wind tunnel testing. The below tables show the observed relative leaf bleaching and cumulative deposition in water (represented by both the percentage of applied herbicide and amount of deposition). LOQ stands for limit of quantification.

TABLE 3
Stellaria leaf bleaching.

| | Relative leaf bleaching | | | |
|---|---|---|---|---|
| | (% average) | | | |
| Component | 1 m | 5 m | 10 m | 20 m |
| F9600-4 (Bixlozone SC) (300 g ai/ha) | 13 | 7 | 1 | 0 |
| Bixlozone ZC (300 g ai/ha) | <1 | 0 | 0 | 0 |

TABLE 4
Cumulative deposition in water.

| | Percentage of applied (%) | | | | | |
|---|---|---|---|---|---|---|
| Component | 1 m | 3 m | 5 m | 10 m | 15 m | 20 m |
| F9600-4 (bixlozone | 0.42 | 0.2 | 0.14 | 0.08 | 0.04 | 0.03 |
| SC) (300 g ai/ha) | | | | | | |
| Bixlozone ZC (300 | 0.04 | 0.02 | 0.01 | <LOQ | <LOQ | <LOQ |
| g ai/ha) | | | | | | |

TABLE 5
Cumulative deposition in water.

| | Amount of applied (μg/m²) | | | | | |
|---|---|---|---|---|---|---|
| Component | 1 m | 3 m | 5 m | 10 m | 15 m | 20 m |
| F9600-4 (bixlozone | 134.6 | 64.06 | 45.14 | 24.09 | 14.07 | 10.11 |
| SC) (300 g ai/ha) | | | | | | |
| Bixlozone ZC (300 | 11.76 | 6.53 | 4.59 | <LOQ | <LOQ | <LOQ |
| g ai/ha) | | | | | | |

This example demonstrates the superior safety to non-target plants for encapsulated bixlozone compared to non-encapsulated bixlozone.

### Example 4. Volatility Effect of Encapsulated and Non-Encapsulated Bixlozone Formulations when Applied to Bare Soil

A greenhouse study was conducted to determine the area of common chickweed effected by volatility of various herbicides at 1000 g ai/ha. Prior to initiation of test, 7.5 cm pots were filled with metro-mix and seeded with common chickweed. Chickweed was grown until the pot was completely covered with foliage. Each herbicide treatment was replicated with 3 individual rings, and 3 non-treated controls were included. Herbicide treatments were applied to Matapeake soil in 10 cm² plastic pots. Treatments were applied using compressed air in a track spray chamber at 280 L/ha (30 gallons per acre) using a TeeJet 8001E nozzle at 275 kpa (40 psi) (SOP #901). Immediately after application each pot was covered with plastic.

Once all treatments were applied, treated pots were moved to a greenhouse. One treated pot was placed in the center of each ring of chickweed, then the plastic covering was removed. No overhead water was applied to any plant or pot for the duration of the test. Water and fertilizer to maintain chickweed was applied by subsurface irrigation. For each chickweed spoke, a measurement was recorded (cm) capturing the furthest visual observation of volatility from the center of the spoke (center of treated 10 cm pot). Evidence of volatility was noted as bleaching on the leaf of chickweed. Eight measurements were taken for each ring at each observation date. Data were analyzed using Minitab statistical software at 95% confidence interval.

The data of this test are in the below table. DAT stands for days after treatment.

TABLE 4
Greenhouse testing.

| | Total area with visible effect | | | | | |
|---|---|---|---|---|---|---|
| | due to volatility (cm²) | | | | | |
| Component | 3 DAT | | 7 DAT | | 10 DAT | |
| Non-treated | 0 | B | 0 | B | 0 | C |
| F9600-4 (bixlozone SC) (1000 | 703 | B | 4368 | A | 3796 | AB |
| g ai/ha) | | | | | | |
| bixlozone ZC (1000 g ai/ha) | 509 | B | 2314 | AB | 2491 | BC |
| Formulation-8 | 817 | B | 3504 | AB | 3648 | AB |
| Formulation-5 | 727 | B | 2372 | AB | 2892 | B |
| Formulation-6 | 511 | B | 2445 | AB | 2664 | B |
| Formulation-7 | 412 | B | 2104 | AB | 2616 | B |

* values in a column that share the same letter are not statistically different

No cross contamination was observed in this greenhouse test, determined by a complete lack of visible bleaching on any chickweed plant for the non-treated control rings. At the first rating interval, all herbicide treatments showed signs of volatility. As the study progressed, the bleached area became larger with all treatments. For the bixlozone compositions, at 10 DAT, F9600-4 (bixlozone SC) affected the largest area and Bixlozone ZC volatilized least.

### Example 5. Phytoxicity Studies

The phytotoxicity of encapsulated and non-encapsulated bixlozone compositions were assessed for winter wheat. The compositions were applied at pre-emergence and early post-emergence.

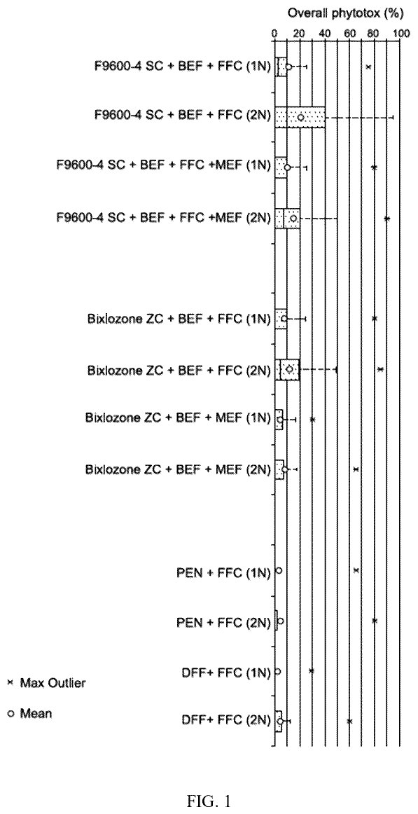

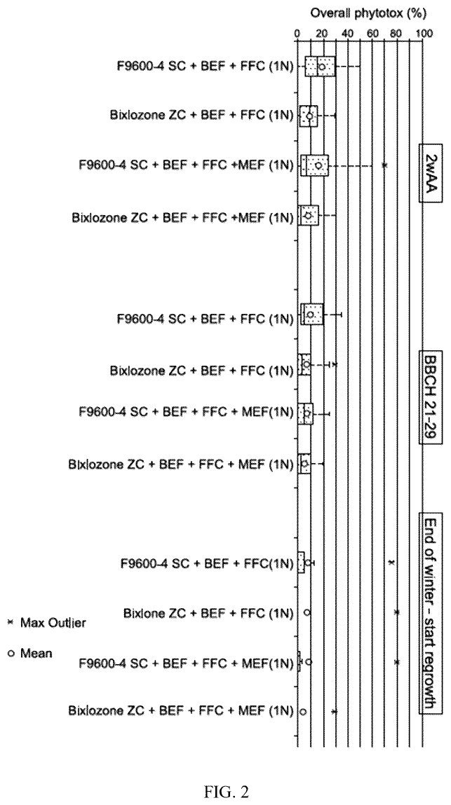

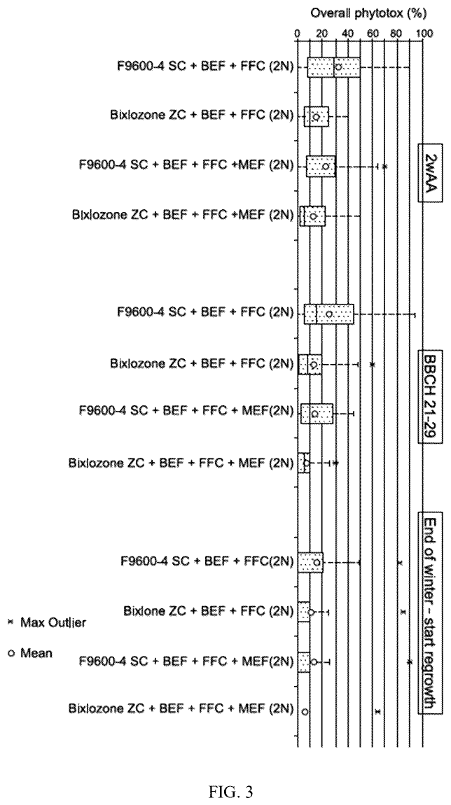

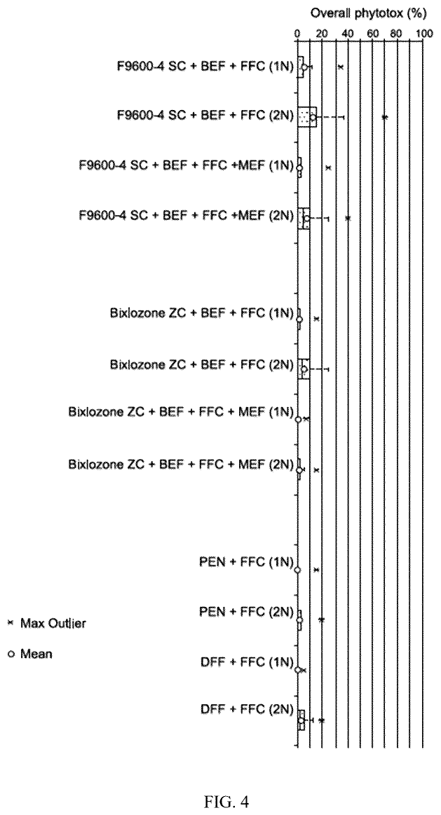

Results of this example are shown in FIG. 1 to FIG. 4 (FIG. 1 to FIG. 4). The numbers in parentheses indicate the normality of the applied compositions. It was determined that a safener had little to no effect compared to the bixlozone compositions without a safener. 2wAA means two weeks after application and BBCH 21-29 means tillering stage of the cereals.

### Example 6. Crop Injury Studies

The maximum crop injury from encapsulated and non-encapsulated bixlozone compositions were assessed for corn. The compositions were applied at post-seeding pre-emergence and post-emergence.

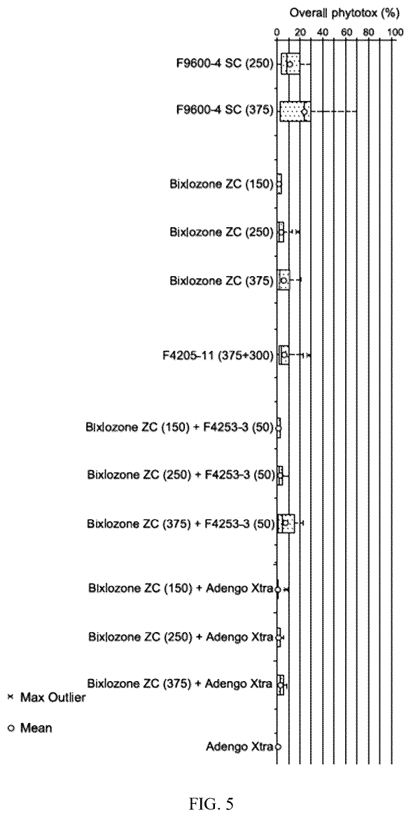

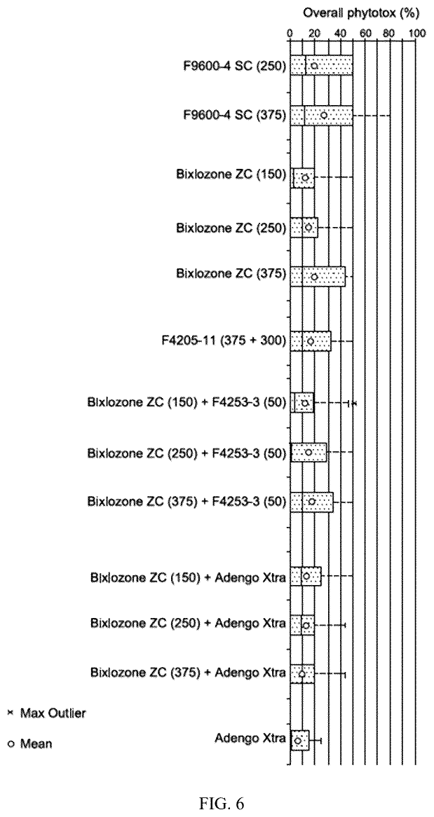

Results of this example are shown in FIGS. 5-6. The numbers in parentheses indicate the application rate of the applied compositions in g ai/ha.

In FIG. 5, it was determined that there was acceptable crop injury for Bixlozone ZC and F4205-11 at post-emergence timing of BBCH 11-12. BBCH 11-12 means one to two true leaves of the crop. The observed symptoms were mainly leaf bleaching/chlorosis, with occasional stunting at 375 g ai/ha. These symptoms were always transient, and there was no noticeable crop response in 2 out of 6 trials. Mixtures including Adengo Xtra (containing cyprosulfamide) exhibited reduced crop injury. However, there was no observed effect with cloquintocet-mexyl.

In FIG. 6, it was determined that there was unacceptable crop injury for Bixlozone ZC (250 and 375 g ai/ha) and F4205-11 at post-emergence timing of BBCH 13-15. BBCH 13-15 means three to five true leaves of the crop. The observed symptoms were mainly leaf bleaching/chlorosis, with occasional stunting. These symptoms were always transient, even if more persistent compared to early stages of post-emergence of the crop, and there was no noticeable crop response in 2 out of 6 trials. Mixtures including Adengo Xtra (containing cyprosulfamide) exhibited reduced crop injury. This was mainly visible at high rates. However, there was no observed effect with cloquintocet-mexyl.

1. A composition comprising:
(i) encapsulated bixlozone;
(ii) non-encapsulated bixlozone; and
(iii) optionally an additional active ingredient,
wherein the composition does not comprise a safener.

2. The composition of claim 1, wherein the non-encapsulated bixlozone is provided by an encapsulated bixlozone that diffuses non-encapsulated bixlozone immediately upon dilution.

3. The composition of claim 1, wherein the encapsulated bixlozone and the non-encapsulated bixlozone are present in a ratio in the range of from about 1:9 to about 9:1.

4. The composition of claim 3, wherein the encapsulated bixlozone and the non-encapsulated bixlozone are present in a ratio in the range of from about 1:3 to about 3:1.

5. composition of claim 4, wherein the encapsulated bixlozone is encapsulated with a material selected from synthetic polymers, polyureas, polyurethanes, polyacrylates, polyamides, polyvinyl alcohols, polyvinylpyrrolidones, semi-synthetic materials, modified celluloses, modified starch derivatives, natural materials, gum Arabic, agar agar, dextrins, alginic acid, alginic acid salts, biodegradable natural polymers, collagen, polysaccharides, starch, dextrin, waxes, chitosan, alginate, cellulose, gelatin, derivatives thereof, and combinations thereof.

6. The composition of claim 5, wherein the additional active ingredient is selected from beflubutamid, beflubutamid-M, pethoxamid, clomazone, and combinations thereof.

7. The composition of claim 6, wherein the additional active ingredient is encapsulated with a material selected from synthetic polymers, polyureas, polyurethanes, polyacrylates, polyamides, polyvinyl alcohols, polyvinylpyrrolidones, semi-synthetic materials, modified celluloses, modified starch derivatives, natural materials, gum Arabic, agar agar, dextrins, alginic acid, alginic acid salts, biodegradable natural polymers, collagen, polysaccharides, starch, dextrin, waxes, chitosan, alginate, cellulose, gelatin, derivatives thereof, and combinations thereof.

8. The composition of claim 7, wherein the encapsulated bixlozone is encapsulated separately from the additional active ingredient.

9. The composition of claim 8, wherein the composition further comprises an auxiliary selected from dispersants, surfactants, biocides, antifoamers, antifreeze agents, rheology modifiers, wetting agents, solvents, salts, and combinations thereof.

10. The composition of claim 9, wherein the composition is in a form selected from a premix and a tank mix.

11. A method of preparing a composition, the method comprising:
I) encapsulating bixlozone; and
II) forming a mixture comprising:
(i) the encapsulated bixlozone;
(ii) non-encapsulated bixlozone; and
iii) optionally an additional active ingredient,
wherein the composition does not comprise a safener.

12. The method of claim 11, wherein the encapsulated bixlozone is encapsulated with a material selected from synthetic polymers, polyureas, polyurethanes, polyacrylates, polyamides, polyvinyl alcohols, polyvinylpyrrolidones, semi-synthetic materials, modified celluloses, modified starch derivatives, natural materials, gum Arabic, agar agar, dextrins, alginic acid, alginic acid salts, biodegradable natural polymers, collagen, polysaccharides, starch, dextrin, waxes, chitosan, alginate, cellulose, gelatin, derivatives thereof, and combinations thereof.

13. The method of claim 12, further comprising encapsulating the additional active ingredient before forming the mixture.

14. The method of claim 13, wherein the additional active ingredient is encapsulated with a material selected from synthetic polymers, polyureas, polyurethanes, polyacrylates, polyamides, polyvinyl alcohols, polyvinylpyrrolidones, semi-synthetic materials, modified celluloses, modified starch derivatives, natural materials, gum Arabic, agar agar, dextrins, alginic acid, alginic acid salts, biodegradable natural polymers, collagen, polysaccharides, starch, dextrin, waxes, chitosan, alginate, cellulose, gelatin, derivatives thereof, and combinations thereof.

15. The method of claim 14, wherein the encapsulated bixlozone is encapsulated separately from the additional active ingredient.

16. A method for controlling undesirable vegetation, the method comprising applying to the undesirable vegetation or to a locus thereof or applying to a soil or crop to prevent an emergence or growth of the undesirable vegetation a composition comprising:
(i) encapsulated bixlozone;
(ii) non-encapsulated bixlozone; and
(iii) optionally an additional active ingredient,
wherein the composition does not comprise a safener.

17. The method of claim 16, wherein the vegetation comprises at least one herbicide resistant or herbicide-tolerant weed species.

18. The method of claim 17, wherein the vegetation comprises a weed selected from a broad leaf weed and a grass weed.

19. The method of claim 18, wherein the vegetation is selected from Abutilon theophrasti (ABUTH), Acalypha virginica (ACCVI), Alopecurus myosuroides (ALOMY), Amaranthus retroflexus (AMARE), Ambrosia artemisiifolia (AMBEL), Anagallis arvensis (ANGAR), Apera spica-venti (APESV), Arrhenatherum elatius (ARREB), Calystegia sepium (CAGSE), Capsella bursa-pastoris (CAPBP), Centaurea cyanus (CENCY), Chenopodium album (CHEAL), Chenopodium hybridum (CHEHY), Chenopodium polyspermum (CHEPO), Convolvulus arvensis (CONAR), Cynodon dactylon (CYNDA), Cyperus difformis (CYPDI), Cyperus iria (CYPIR), Datura stramonium (DATST), Daucus carota (DAUCA), Descurainia sophia (DESSO), Digitaria sanguinalis (DIGSA), Echinochloa crus-galli (ECHCG), Echinochloa colonum (ECHCO), Fumaria officinalis (FUMOF), Galium aparine (GALAP), Galinsoga quadriradiata (GASCI), Geranium dissectum (GERDI), Geranium mole (GERMO), Geranium pusillum (GERPU), Hibiscus trionum (HIBTR), Lamium amplexicaule (LAMAM), Lamium purpureum (LAMPU), Buglossoides arvensis (LITAR), Lolium multiflorum (LOLMU), Lolium perenne (LOLPE), Lolium rigidum (LOLRI), Matricaria chamomilla (MATCH), Tripleurospermum inodorum (MATIN), Mercurialis annua (MERAN), Panicum dichotomiflorum (PANDI), Panicum miliaceum (PANMI), Papaver rhoeas (PAPRH), Phalaris minor (PHAMI), Poa annua (POAAN), Polygonum aviculare (POLAV), Fallopia convolvulus (POLCO), Persicaria hydropiper (POLHY), Persicaria lapathifolia (POLLA), Persicaria maculosa (POLPE), Portulaca oleracea (POROL), Potentilla tridentate (PTLTR), Senecio vulgaris (SENVU), Setaria pumila (SETPU), Setaria viridis (SETVI), Solanum nigrum (SOLNI), Sorghum halepense (SORHA), Stellaria media (STEME), Trifolium incarnatum (TRFIN), Veronica arvensis (VERAR), Veronica hederifolia (VERHE), Veronica persica (VERPE), Viola arvensis (VIOAR), and Xanthium strumarium (XANST), and combinations thereof.

20. The method of claim 18, wherein the composition is applied at a stage selected from pre-emergence, post-emergence, and combinations thereof.

21. (canceled)
